(19) United States
(12) Patent Application Publication
(10) Pub. No.: US 2013/0096098 A1
(43) Pub. Date: Apr. 18, 2013

(54) Light Insensitive Silver(i) Cyanoximates As Antimicrobial Agents For Indwelling Medical Devices

(71) Applicants: Nikolay Gerasimchuk, Springfield, MO (US); Andrzej Garmian, Wroclaw (PL)

(72) Inventors: Nikolay Gerasimchuk, Springfield, MO (US); Andrzej Garmian, Wroclaw (PL)

(73) Assignee: MISSOURI STATE UNIVERSITY, Springfield, MO (US)

(21) Appl. No.: 13/612,501

(22) Filed: Sep. 12, 2012

Related U.S. Application Data
(60) Provisional application No. 61/533,604, filed on Sep. 12, 2011.

(51) Int. Cl. A01N 55/02

(52) U.S. Cl. CPC A01N 55/02
USPC 514/186; 514/495; 514/188; 548/108; 546/12; 556/110

(57) ABSTRACT

Silver(I) cyanoximates of AgL composition (L=NC—C(NO)—R, where R is electron withdrawing groups: —CN, —C(O)NR₂, —C(O)R′ (alkyl), —C(O)OEt, 2-heteroaryl fragments such as 2-pyridyl, 2-benzimidazolyl, 2-benzoxazolyl, 2-benzthiazolyl) are synthesized and characterized using spectroscopic methods and X-ray analysis. The synthesized compounds also demonstrate remarkable insensitivity toward visible light and UV-radiation. The combined characteristics of these compounds, such as light insensitivity, poor water solubility, high thermal stability, lack of toxicity of organic ligands, and antimicrobial activity make these silver(I) cyanoximates compounds suitable for use in biomaterial and medical devices.

### RELATED APPLICATIONS

This application claims priority to U.S. Patent application 61/533,604 filed Sep. 12, 2011, the entire content of which is hereby incorporated by reference into this application.

### INTRODUCTION

The number of patients requiring an internal fixation device or artificial joint has grown rapidly. In the United States alone, more than 4.4 million people have at least one internal fixation device and more than 1.3 million people have an artificial joint. Bacterial infection induced by an implant placement (FIG. 1A) is a significant rising complication and is associated with considerable morbidity and costs. These device-related infections caused by Pseudomonas aeruginosa are usually acute and extremely difficult to treat. Initial symptoms of these infections are usually transient, allowing further infection development. Even immediate device replacement and long-term administration of high-dose antibiotics are often ineffective. Streptococcus mutans is considered an early colonizer of the tooth surface and one of the major causes of caries development in humans. The ability of these bacteria to produce biofilms on the surfaces of biomaterials used during surgeries is one of the main causes of developing stubborn infections. Biofilms have an increased resistance to antibiotics and host defenses. As a result, they are notoriously difficult to eradicate, and are a source of many recurrent infections.

Clinical practice has shown that systemic antibiotics are unable to provide effective treatment for implant-associated infections. At the present time, only a high dose of antibiotics applied locally at the bone-implant interface can prevent such bacterial infections. However, this treatment causes a number of side effects, such as increased bacterial resistance to antibiotics, allergic reactions, and microbial flora depletion. Thus, it is often the best solution to remove the device, treat the infection, and repeat surgical introduction of a new device. This kind of procedure is costly, both financially and psychologically, as well as time-consuming.

Due to the rapid increase in use of artificial implants, it is critical that new strategies to prevent infection are developed, and in particular, antibacterial agents. One of the interesting options is the introduction of a non-antibiotic antimicrobial substance, for example, into the glue used during introduction of indwelling medical devices (Scheme 1 in FIG. 1) or surface treatment of such devices to prevent pathogenic cell adhesion and biofilm formation. There is a critical need for non-antibiotic compounds that satisfy specific needs to be water insoluble, light- and chemically stable, and yet could survive sterilization at 100° C. without decomposition. Pure organic compounds cannot meet these criteria, but some water-insoluble metal complexes—for example silver(I) compounds as shown in Scheme 1B (FIG. 1) may meet these criteria.

Silver has long been known to exhibit strong inhibitory and bactericidal effects as well as a broad spectrum of antibacterial properties. Since ancient times, people have known that water can remain suitable for drinking for a long time if stored in silver jars. Colloidal silver and silver nitrate have been used safely in burn therapy, urinary tract infections, and central venous catheter infections. The inhibitory effects of silver and silver compounds on bacteria is believed to be associated with silver reacting with microbial DNA or the sulfhydryl groups found in the enzymes of bacterial electron transport chains, causing its inactivation. One of the applications of silver and its compounds is reduction of postoperative infections caused by implants. Intrinsically low toxicity silver compounds have been loaded into several implant materials such as bioglass and bone cement, and the resulting material may be used for implant therapies in the health care industry. However, no silver(I) compounds have been reported which demonstrate combined light and thermal stability, chemical inertness, water insolubility, and antimicrobial activity. The main problems appear to be poor knowledge, insufficient development, and lack of subsequent studies of organic ligands to provide such properties.

### SUMMARY

The present disclosure advances the art by providing an anti-microbial material suitable for use in biomaterials and medical devices. In one embodiment, ten silver(I) cyanoximates of AgL composition (L=NC—C(NO)—R, where R is electron withdrawing groups: —CN, —C(O)NR₂, —C(O)R′ (alkyl), —C(O)OEt, 2-heteroaryl fragments such as 2-pyridyl, 2-benzimidazolyl, 2-benzoxazolyl, 2-benzthiazolyl) have been synthesized and characterized using spectroscopic methods and X-ray analysis. Crystal structures of four complexes are disclosed which reveal the formation of two-dimensional (2D) coordination polymers of different complexity in which anions exhibit bridging or combined chelate and bridging binding modes. In another embodiment, anions are in the nitroso form in these compounds.

In one aspect, the disclosed AgL complexes are sparingly soluble in water and are thermally stable to a temperature as high as 150° C. The synthesized compounds disclosed herein demonstrate relatively high insensitivity toward visible light and UV-radiation, which may be explained based on their polymeric structures with multiple covalent bonds between bridging cyanoxime ligands and Ag(I) centers. All ten silver(I) cyanoximates are tested in vitro on the subject of their antimicrobial activity against both Gram-positive and Gram-negative microorganisms such as Escherichia coli, Klebsiella pneumoniae, Proteus sp., Pseudomonas aeruginosa, Enterococcus hirae, Streptococcus mutans, Staphylococcus aureus, and Mycobacterium fortuitum as well as against Candida albicans in solutions, and in the solid state as pressed pellets and dried filter paper disks presoaked with solutions of AgL in DMF. Results showed pronounced antimicrobial activity for these complexes.

In one embodiment, the combination of at least the following five factors allows for the use of silver(I) cyanoximates in biomaterials and medical applications: (1) light insensitivity, (2) poor water solubility, (3) high thermal stability, (4) lack of toxicity of organic ligands, and (5) in vitro antimicrobial activity. In one aspect, the disclosed compounds may be included as antimicrobial additives to acrylate glue. In another aspect, the disclosed compounds may be cured by UV-radiation, and may be used in introduction of prosthetic joints and dental implants. In another aspect, the disclosed compounds may also be used for the prevention of biofilm formation on several types of indwelling medical devices.

One particular class of low molecular weight organic compounds can act as ligands for binding silver(I) cations and form complexes that may satisfy all the specific requirements outlined above. The disclosed compounds are species of a class of compounds known as oximes, which represent versatile organic molecules that have been extensively used as excellent ligands in analytical, inorganic, and bioinorganic chemistry. Furthermore, among oximes one specific group of substances called cyanoximes—compounds with the general formula HO—N═C(CN)—R— represents a new, special class of biologically active molecules that are also capable of binding to different metal ions.

In one embodiment, the presence of the CN-group in these compounds significantly increases their acidity and makes them better ligands for binding metal ions as compared to conventional monoximes. Earlier data showed no intrinsic in vitro cytotoxicity of free organic cyanoximes. Here, it is shown that silver(I) cyanoximates are insoluble in water, represent thermally and chemically stable compounds, and exhibit antimicrobial activity. With the exception of several publications and presentations, no systematic studies have been reported regarding light-stable silver(I) antimicrobial compounds targeting specific infections, and no oxime-based compounds have been tested on that matter at all.

In this disclosure, results relating to systematic investigation of the synthesis, spectroscopic, structural and photophysical characterization, for a new group of light-insensitive silver(I) cyanoximates are shown. This new group of light-insensitive silver(I) cyanoximates is primarily based on ligands shown in Scheme 2 in FIG. 2. Functional studies are also disclosed showing anti-microbial activity of the disclosed compounds.

### BRIEF DESCRIPTION OF THE DRAWINGS

FIG. 1 (Scheme 1) illustrate introduction of a non-antibiotic antimicrobial substance into the glue used during introduction of indwelling medical devices.

FIG. 2 (Scheme 2) shows the ligands of the ten light insensitive silver(I) cyanoxime complexes that are synthesized and characterized.

FIG. 3 (Scheme 3) shows the preparation of cyanoximes and their Ag(I) complexes as an example.

FIG. 4 shows the crystal structures of some silver(I) cyanoximates molecules. Displayed are one anion and its closest Ag(I) environments in Ag(ACO)—A, Ag(DCO)—B, Ag(PiCO)—C, Ag(ECO)—D. An ORTEP drawing at 50% thermal ellipsoids probability level. Disordered methanol molecules in the structure of Ag(DCO) and mirror image of the disordered ethoxy-group in the structure of Ag(ECO) are not shown for clarity.

FIG. 5 shows the geometries of coordination polyhedrons in silver(I) cyanoximates: A—Ag(ACO), B—Ag(DCO), C—Ag(PiCO), D—Ag(ECO).

FIG. 6 shows the Organization of covalent 2D-polymers in the structures of Ag(ACO) (A), Ag(DCO) (B), Ag(PiCO) (C), and Ag(ECO) (D). H-atoms of the amide group in the structure of Ag(ACO) are omitted for clarity. Coloring scheme: magenta—Ag, gray—C, red—O, blue—N.

FIG. 7 shows vials with silver(I) cyanoximates showing the time of exposure to daylight.

FIG. 8 shows the resistance of synthesized solid silver(I) cyanoximates Ag-(CCO), Ag(ACO), Ag(DCO), and Ag(PiCO) toward high-energy UVradiation at 254 nm in comparison to conventional light-sensitive silver chloride.

FIG. 9 shows the “Light insensitive motif” in Ag(I) cyanoximates. Solid red lines—absolutely necessary to have bridging nitroso-group: 6 out of 6 cases; dashed red line—binding of silver atom via the cyano-group, and formation of a second bridge via the oxygen atom of the nitroso group: both present in 4 out of 6 cases.

FIG. 10 shows photographs of agar plates showing zones of inhibition by AgL pellets in two cultures on solid media: in Pseudomonas aeruginosa (A—bottom view, B—top view) and in Mycobacterium fortuitum (C—bottom view, D—top view) growth on solid media.

### DETAILED DESCRIPTION

Light insensitive and stable compounds possessing desirable anti-microbial properties are disclosed. The compounds may be suitable for use in biomaterials and medical devices.

By way of example, ten silver(I) cyanoximates were synthesized and characterized using elemental analyses, spectroscopic methods, and X-ray analysis. Five complexes were obtained and characterized for the first time, while crystal structures were determined for four compounds. All synthesized Ag(I) complexes have demonstrated thermal stability upon heating up to 150° C. and a remarkable light insensitivity. That includes years of exposure to daylight or hours of direct exposure to the short wavelength (254 nm) UV-radiation. The antimicrobial activity of all obtained silver(I) cyanoximates was tested both in solutions and in the solid state against Escherichia coli, Klebsiella pneumoniae, Proteus sp., Pseudomonas aeruginosa, Enterococcus hirae, Streptococcus mutans, Staphylococcus aureus, Mycobacterium fortuitum, Candida albicans, and in addition on several multidrug-resistant bacterial strains isolated from patients with nosocomial infections K. pneumoniae 244, P. aeruginosa, Streptococcus pneumoniae PCI, AMA, Enterococcus faecium VRE (vancomycin-resistant), S. aureus MRSA (methicillin-resistant). Examination of fresh clinical isolates from nosocomial infections revealed the data valuable for application purposes of the investigated compounds. Results have indicated pronounced antimicrobial activity of studied complexes.

A combination of four properties including (1) thermal stability, (2) light insensitivity, (3) poor water solubility, and (4) antimicrobial activity is important for their intended potential applications in indwelling medical devices. Thus, visible light insensitive silver(I) complexes with anti-microbial activity will offer benefits as an adjunct or alternative material compared to current materials used for implants. Inertness of these metal compounds toward intense UV-light allows their application as additives to UV-radiation curable polymeric glues in joint replacement therapy and dental implant insertions. Because bacterial adhesion and biofilm formation are important predisposing factors in the development of clinical implant infection, it is crucial that silver(I) cyanoximates showed an effect on their development. A significant thermal resistance of these complexes is essential for equipment sterilization, while poor water solubility will prevent compounds from leaching out from solidified polymeric composites, or from the surface of indwelling devises. Silver(I) complexes introduced in polymeric acrylate glue composites will prevent infection from occurring.

The silver(I) cyanoximates may be added to conventional acrylate-based light-curable glues used in medical practice during introduction of indwelling devices. Light-induced bulk polymerization may be conducted. Samples for these materials may be in the form of disks or small cylinders in order to model conditions and shapes for indwelling medical devices. Mixtures of silver(I) cyanoximates may also be tested to ensure broader microbicidal activity. Because preliminary experiments demonstrated that Ag(I) cyanoximates inhibit microbial growth in liquid and solid media, these complexes may prevent or inhibit bacterial adhesion and biofilm formation. Thus, the effect of Ag(I) complexes on adhesion of P. aeruginosa, S. aureus, and S. mutans may be tested. The inability of bacteria to develop biofilm on the coated surfaces made with the disclosed compounds may be utilized to achieve the anti-microbial objective.

In one embodiment, methods are disclosed for treating indwelling medical devices to eliminate microbes which comprise the steps of applying a water-insoluble silver cyanoximate to the surface of the indwelling medical device prior to or during the introduction of the indwelling medical device into a patient.

In another embodiment, the silver cyanoximate may be selected from the group consisting of: 2-(Oximido)-2-benzoxazoleacetonitrile Silver(I), Ag(BOCO); Silver(I) Nitrosodicyanomethanide, Ag(CCO); Silver(I) α-Oximido-(acetamide)acetonitrile, Ag(ACO); Silver(I) α-Oximido-([N,N-dimethylamine]acetamide)acetonitrile, Ag(DCO); Silver(I) α-Oximido-(ethylacetoxy)acetonitrile, Ag(ECO); Silver(I) α-Oximido-(2-pivaloyl)acetonitrile, Ag(PiCO); Silver(I) α-Oximido-(2-benzoyl)acetonitrile, Ag(BCO); Silver(I) α-Oximido-(2-pyridyl)acetonitrile, Ag(2PCO); Silver(I) α-Oximido-(2-[N-methyl]benzoimidazolyl)acetonitrile, Ag(BIMCO); Silver(I) α-Oximido-(2-benzothiazolyl)acetonitrile, Ag(BTCO).

In another embodiment, an antimicrobial additive is disclosed which may be added to acrylate glue for securing an indwelling medical device, wherein the additive comprises at least one silver cyanoximate. In one aspect, the additive may contain a silver cyanoximate selected from the group consisting of: 2-(Oximido)-2-benzoxazoleacetonitrile Silver(I), Ag(BOCO); Silver(I) Nitrosodicyanomethanide, Ag(CCO); Silver(I) α-Oximido-(acetamide)acetonitrile, Ag(ACO); Silver(I) α-Oximido-([N,N-dimethylamine]acetamide)acetonitrile, Ag(DCO); Silver(I) α-Oximido-(ethylacetoxy)acetonitrile, Ag(ECO); Silver(I) α-Oximido-(2-pivaloyl)acetonitrile, Ag(PiCO); Silver(I) α-Oximido-(2-benzoyl)acetonitrile, Ag(BCO); Silver(I) α-Oximido-(2-pyridyl)acetonitrile, Ag(2PCO); Silver(I) α-Oximido-(2-[N-methyl]benzoimidazolyl)acetonitrile, Ag(BIMCO); Silver(I) α-Oximido-(2-benzothiazolyl)acetonitrile, Ag(BTCO).

It is to be recognized that silver(I) cyanoximates compounds other than the ones synthesized and disclosed may possess similar properties as the compounds that are described in details in the present disclosure.

### EXAMPLES

The following examples illustrate the present disclosure. These examples are provided for purposes of illustration only and are not intended to be limiting. The chemicals and other ingredients are presented as typical components or reactants, and various modifications may be derived in view of the foregoing disclosure within the scope of the invention.

### Example 1

### Materials and Methods

This Example details some of the material, methods, and instruments employed in this disclosure.

Materials and Physical Measurements. Reagent or analytical grade materials were obtained from commercial suppliers (Aldrich and Mallinckrodt) and were used without further purification. Elemental analyses on C, N, H content were performed by a combustion method at the Atlantic Microlab (Norcross, Ga.). Melting points for organic ligands were determined using the UniMelt apparatus (by Thomas-Hoover) without correction. Identification of the obtained organic compounds was carried out using ¹H, ¹³C NMR spectroscopy (Varian INova 400; T=296 K; in DMSO-d₆, with TMS as an internal standard TMS, by Cambridge Laboratories), and mass-spectrometry (positive FAB technique for the macrocyclic compound 14-ane[N₄]; m-nitrobenzylic alcohol, NBA, as a matrix using Autospec Q and ZAB spectrometers from Manchester, UK). IR spectra for synthesized organic cyanoxime ligands were recorded in KBr pellets (400-4000 cm⁻¹ region at 4 cm⁻¹ resolution) using a Nicolet Impact 410 spectrophotometer operating with OMNIC software. At the same time, IR spectra of silver(I) complexes were obtained from mulls in Nujol between two 2 cm KBr disks. Visible spectra for the suspensions of several Ag(I) cyanoximates in mineral oil between two quartz plates 4×1 cm were recorded on an Agilent HP 8453E spectrophotometer in the range of 300-1100 nm at 293 K. Room temperature solid-state diffusion reflectance spectra of Ag(ACO) and Ag(PiCO) were obtained on a Varian Bio-100 spectrophotometer with an integrating sphere and MgO as a standard. Electrical conductivity of 1 mM solutions of synthesized silver(I) cyanoximates in anhydrous DMSO was measured at 296 K using a YSI Conductance-Resistance meter model 34. Solutions of ammonium bromide, tetrabutyl-ammonium bromide, and tetraphenyl-phosphonium bromide (as 1:1 electrolytes), and hydrazinium dichloride (as 1:2 electrolyte) were used for the electrode calibration.

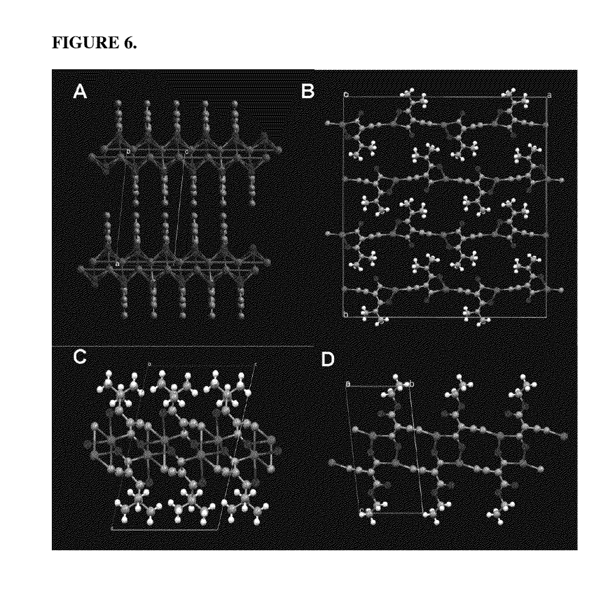

X-ray Crystallography. Suitable crystals of compounds Ag(ACO), Ag(DCO), Ag(PiCO), and Ag(ECO) were mounted on a thin glass fiber on the goniometer head of a Bruker APEX 2 diffractometer equipped with a SMART CCD area detector. All data sets were collected at low temperature. The intensity data for suitable crystals of these compounds were collected in ω scan mode using Mo tube (Kα radiation; λ=0.71073 \acute{Å}) with a highly oriented graphite monochromator. Intensities were integrated from four series of 364 exposures, each covering 0.5° in ω within 20 to 60 s of acquisition time and the total data set being a sphere. The space group determination was done with the aid of XPREP software. Absorption corrections were applied based on crystal face indexing obtained using actual images recorded by video camera. The following data processing was performed using the SADABS program that was included in the Bruker AXS software package. The structures were solved by direct methods and refined by least-squares on weighted F² values for all reflections using the SHELXTL program. All atoms received assigned anisotropic displacement parameters and were refined without positional constraints. All nine hydrogen atoms in the structure of Ag(PiCO) were found on the difference map and their positions were refined as well. Crystals of Ag(ACO) turned out to be multidomain species. Complex Ag(DCO) contained a disordered solvent molecule with partial occupancy. A complete set of bonds and angles around metal centers is presented in FIGS. 6-10. Figures for the crystal structures of these complexes were drawn using Mercury 4.1.2 and ORTEP 32 software at a 50% thermal ellipsoids probability level. The PLATON checks of crystallographic data and actual CIF files for reported structures are known. The X-ray powder diffraction studies of bulk samples of synthesized AgL were carried out at 296 K on a Bruker Discover XRD system using Cu-radiation (Kα radiation; λ=1.5406 \acute{Å}). Powdery samples of complexes were attached to 20×45 mm cardboard rectangles (as sample holders) using a double-sided 12 mm Scotch tape from 3M followed by standard one-sided 19 mm tape.

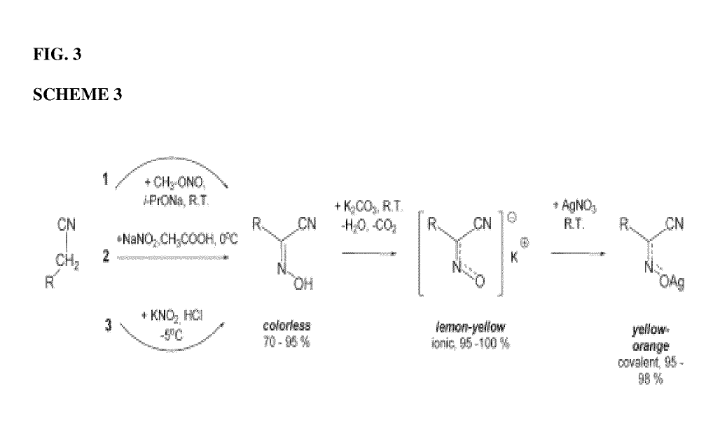

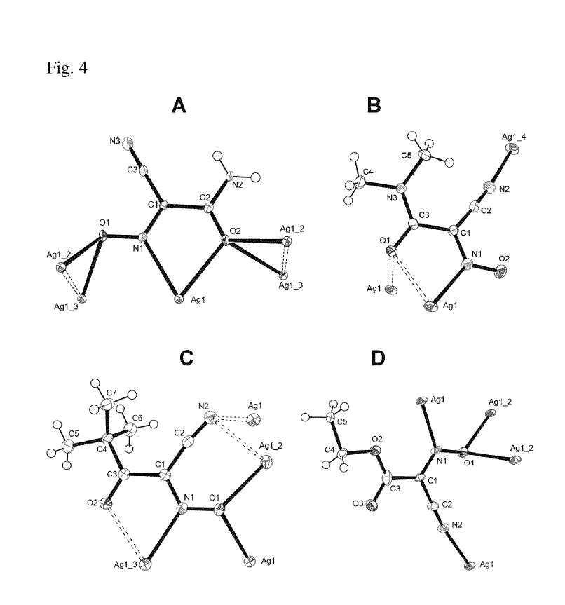

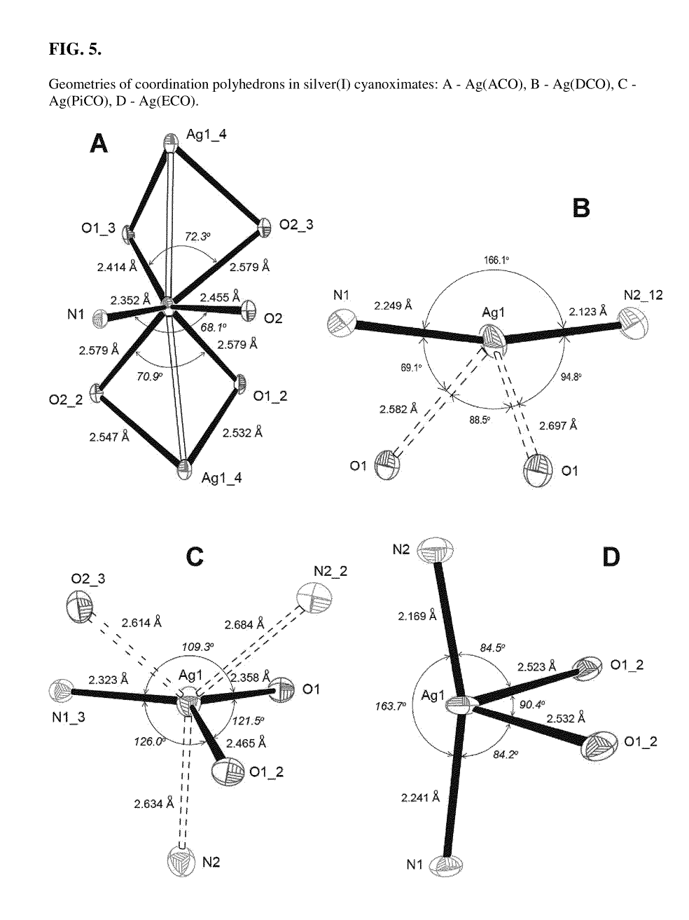

Synthesis of Compounds. Preparation of cyanoximes and their Ag(I) complexes is depicted in Scheme 3 in FIG. 3, while the typical synthesis of silver(I) derivatives is shown as an example for only one compound. Structures of specific compounds are shown at FIGS. 4 and 5 while organization of covalent 2D-polymers can be seen at FIG. 6.

2-(Oximido)-2-benzoxazoleacetonitrile Silver(I), Ag(BOCO). Brown H(BOCO) in the amount of 0.4605 g (2.46 mM) of brown H(BOCO) was dissolved in a mixture of 10 mL of EtOH, diluted with 10 mL of water, heated to +50° C., and then added dropwise to a solution of 0.169 g (1.22 mM) of K₂CO₃ in 10 mL of H₂O. The reaction mixture turned immediately very dark brown and was placed for 2 min into an ultrasound bath to accelerate the evolution of CO₂. A solution of 0.4183 g (2.46 mM) of AgNO₃ in 10 mL of water was added dropwise under intensive stirring to a solution of K(BOCO) above. Mixing resulted in a very fine orange-brown precipitate, which after an additional 20 min of stirring was filtered, washed with three portions of 10 mL of water, and then dried in a vacuum desiccator charged with H₂SO₄ (c) for 3 days. The yield of orange-brown Ag(BOCO) was 98% (0.701 g). Anal. Calc. for C₉H₄AgN₃O₂ (Found) %: C, 36.77 (37.12); H, 1.37 (1.58); N, 14.49 (14.33). Other silver(I) cyanoximates follow.

Silver(I) Nitrosodicyanomethanide, Ag(CCO). Bright-yellow powder; yield 96%, complex decomposes in the range of 190-209° C. Anal. Calc. for C₃N₃OAg (Found) %: C, 17.84 (17.98); N, 20.81 (20.69).

Silver(I) α-Oximido-(acetamide)acetonitrile, Ag(ACO). As shown in FIG. 4A, microcrystalline canary-yellow compound; yield 100%, decomposition>229-232° C. Anal. Calc for C₃H₂AgN₃O₂ (Found): C, 16.38 (16.47); H, 0.92 (0.99); N, 19.11(19.08).

Silver(I) α-Oximido-([N,N-dimethylamine]acetamide)acetonitrile, Ag(DCO).0.5MeOH. As shown in FIG. 4B, Dark-yellow microcrystalline compound obtained with 82% yield, decomposes at ˜158° C. Anal. Calc for C₁₁H₁₆Ag₂N₆O₅ (Found): C, 25.02 (25.11); H, 3.05 (3.09); N, 15.92 (15.63).

Silver(I) α-Oximido-(ethylacetoxy)acetonitrile, Ag(ECO). As shown in FIG. 4D, an orange powder, 93% yield, decomposes at 202-207° C. Anal. Calc for C₅H₅AgN₂O₃ (Found): C, 24.12 (23.98); H, 2.02 (2.06); N, 11.25 (11.11).

Silver(I) α-Oximido-(2-pivaloyl)acetonitrile, Ag(PiCO). As shown in FIG. 4C, a very fine pale yellow powder, yield 85%; rapid decomposition at 160-162° C. Anal. Calc for C₇H₉AgN₂O₂ (Found): C, 32.21 (31.81); H, 3.48 (3.51); N, 10.73 (10.62).

Silver(I) α-Oximido-(2-benzoyl)acetonitrile, Ag(BCO). Purple fine powder obtained with yield 71%; decomposition at 180-182° C. Anal. Calc for C₉H₅AgN₂O₂ (Found): C, 38.47 (38.29); H, 1.79 (1.92); N, 9.97 (9.86).

Silver(I) α-Oximido-(2-pyridyl)acetonitrile, Ag(2PCO). Yellow powder, yield 87%; decomposition at 178-187° C. Anal. Calc for C₇H₅N₃O (Found): C, 33.10 (34.83); H, 1.59 (1.90); N, 16.54 (17.18).

Silver(I) α-Oximido-(2-[N-methyl]benzoimidazolyl)acetonitrile, Ag(BIMCO).0.5H₂O. The compound represents a very fine yellow-green powder, decomposes at 160-180° C.; yield 96%. Anal. Calc for C₁₀H₈AgN₄O₁₅ (Found): C, 37.97 (37.60); H, 3.16 (2.47); N, 17.72 (17.20).

Silver(I) α-Oximido-(2-benzothiazolyl)acetonitrile, Ag(BTCO).1.5H₂O. Orange-brown fine powder; yield 100%; at ˜214-219° C. complex decomposes. Anal. Calc for C₉H₇N₃O₂SAg, %: C, 32.03 (32.18); H, 2.08 (2.31), N, 12.46 (12.86).

All synthesized Ag(I) cyanoximates are sparingly soluble in water, but dissolve in donor solvents such as pyridine, 2-picoline, and DMSO.

Photophysical Measurements. Light sensitivity and stability of synthesized Ag(I) cyanoximates was studied at 296 K using a low-pressure Hg lamp with >85% output at λₘₐₓ=254 nm where the intensity of light was measured with a UVX radiometer (UK). After 4 min warm-up time, this lamp generated a steady flux of UV-radiation that was equal to the dose of 10.13 J/cm² within 30 min. Prior to these investigations, complexes were thoroughly dried under high vacuum (<10⁻⁴ Torr) and ground into a powder using an agate mortar. This made it easy to apply these compounds to paper, adhesive tape, or cardboard. Samples of complex were spread on white cardboard with an exposed circular area (via a mask) of ˜3 cm. The radiation source was positioned 1 cm from the sample. A pristine white silver chloride prepared in the dark was used as a control substance to access the light stability of silver(I) cyanoximates. Digital pictures of irradiated samples were taken every 30 min using a stationary digital camera (Kodak DX7630; 6.1 Mpx), and native images were cropped to square shape without any contrast or brightness editing using Samsung Digimax Viewer 2.0 software.

Antimicrobial Activity Studies. Bacterial Strains and Growing Conditions. The strains of bacteria were obtained from Polish Collection of Microorganisms (PCM) of the Institute of Immunology and Experimental Therapy of Polish Academy of Sciences and were used throughout this study. Both Gram-negative and Gram-positive bacteria, as well as yeasts, commonly isolated from patients suffering implant-related infections, were chosen for experiments. They included Escherichia coli PCM 1144 (ATCC #10536), Klebsiella pneumoniae PCM 57, Proteus sp. PCM 542 (ATCC #13315), Pseudomonas aeruginosa PCM 2563 (ATCC #15442), Streptococcus mutans PCM 2502, Staphylococcus aureus PCM 2602 (ATCC #6538), Enterococcus hirae PCM 2559 (ATCC #10541), Mycobacterium fortuitum PCM 672, Candida albicans PCM 2566 (ATCC #10231). In addition, several multidrug-resistant bacterial strains isolated from patients with nosocomial infections K. pneumoniae 244, P. aeruginosa 2314, AMA, Enterococcus faecium VRE (vancomycin-resistant), Streptococcus pneumoniae PCI, S. aureus MRSA (methicillin-resistant), S. aureus MRSC (coagulase-negative methicillin-resistant), were also included in the in vitro testing. Bacteria were cultivated on sugar broth at 37° C. for 24 h in aerobic conditions, and prior to use in tests, cells were diluted with the same medium to obtain suspensions of about 2×10⁵ cfu/mL.

Antibacterial Tests in Solutions. The antibacterial activities of synthesized Ag(I) cyanoximates were determined against bacterial strains by the microplate Alamar Blue assay. Stock solutions of AgL compounds were prepared in DMSO (1 mg/mL) and then were diluted with appropriate media in the range from 0.03 to 1000 μg/mL on the cell culture microtitration plate. Aliquots of 100 μL of the studied AgL compound at different concentrations and 100 μL of the diluted suspension of the bacterial cells were added to wells. Control wells contained either bacteria only or medium only, and plates were incubated at 37° C. for 48 h. After that, solutions of 20 μL of Alamar Blue reagent (AbD Serotec) (10×diluted) and 12.5 μL of 20% Tween 80 were added to wells and incubation was continued at 37° C. for 2 more hours. The fluorescence was measured using Victor² apparatus (Wallac, Perkin-Elmer), and the experiment was repeated three times. The minimal inhibitory concentration (MIC) was defined as the lowest drug concentration which prevented a color change from blue to pink, inhibiting the bacterial growth for ≧90%. Means and standard error values were determined using the Microsoft Excel.

Antibacterial Tests in Solid State: Soaked Dried Paper Disks and Pellets. Solutions (or suspensions if the compound was not completely solubilized) of studied Ag(I) cyanoximates in DMF at 10 mg/mL concentration were prepared and 20 μL of it was placed on filter paper discs (diameter 12 mm). These discs were dried for ˜2 h in the dark prior to testing where each filter was placed on agar plates with inoculated microorganisms, which were then incubated at 37° C. for 24 h. Thereafter, microorganisms' growth inhibition zone (if present) was measured (in mm).

Also, Ag(I) cyanoximates were pressed into 12 mm in diameter pellets using a Carver 20 tons hydraulic press. The method of testing pellets was similar to the one described above. Solid pellets of AgL were carefully placed on agar plates with inoculated bacteria. The exposition time was 24 h at 37° C., after which inhibition zones were measured and results were documented by digital photography.

### Example 2

### Synthesis and Characterization of Silver(I) Cyanoxime Complexes

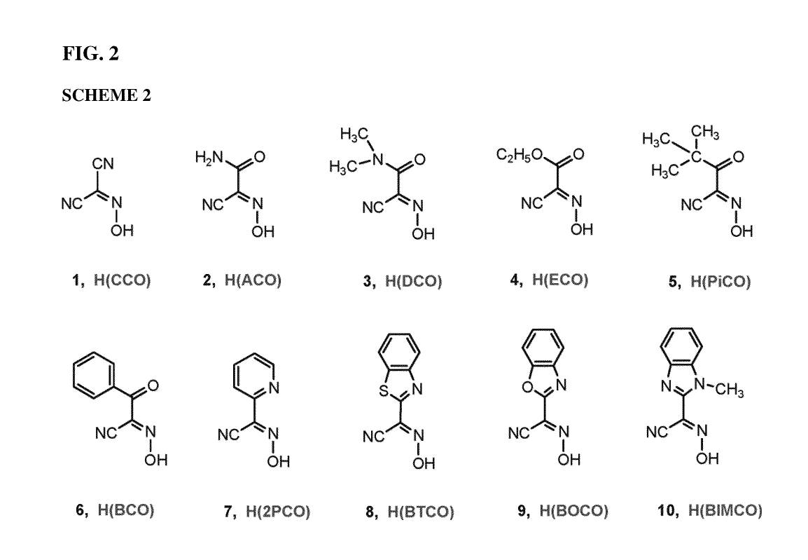

Ten light insensitive silver(I) cyanoxime complexes (or compounds) with ligands shown in Scheme 2 (FIG. 2) were synthesized and characterized using spectroscopic methods, X-ray analysis, and in vitro antimicrobial studies. Description of properties of the obtained compounds is presented below in a systematic way starting from the chemical part of this work, continued by photophysical studies, and then followed by biological investigations.

Chemical Part: Synthesis and Characterization of Ligands and Metal Complexes. A methodology for a high-yield preparation of cyanoximes from substituted acetonitriles has been developed and is disclosed herein. The R—CH₂—CN compounds are mostly commercially available pure substances which can be converted in a one-step procedure to respective cyanoximes (Scheme 3 in FIG. 3). These are three different routes of the Meyer reaction, which depending on the reactivity of the methylene group of starting acetonitrile were applicable for the preparation of different cyanoximes. Room temperature nitrosation using gaseous methyl nitrite CH₃—ONO is the most convenient reaction that has been successfully used for synthesis of a variety of cyanoximes. These compounds represent nice crystalline substances that can be easily purified by recrystallization in the presence of activated carbon, or by flash column chromatography on silica.

Identification and characterization of the obtained and purified organic molecules were carried out using elemental analyses, thin-layer chromatography (TLC), and spectroscopic methods such as UV-visible, IR, ¹H, ¹³C NMR spectroscopy (including 2D COSY, HMQC, and HSQC experiments). Ligands shown in Scheme 2 have the ability to form chelate complexes and also act as bridging ligands. They possess interesting features—electronic and structural—that are reflected in their hydrophilic/hydrophobic character and acidity (ligands 1-6, Scheme 2), the ability to form layered structures in the solid state due to π-π stacking interactions between heterocyclic groups (ligands 7-10, Scheme 2), and, finally, multiple donor centers capable of tightly binding silver(I) atoms to form coordination polymers of different complexity. Coordination compounds of the latter metal are particularly interesting: they have unusual structures, show properties of gas-sensing materials, and lately demonstrate antimicrobial activity. These aforementioned electronic and structural factors allow the fine-tuning of properties of the obtained Ag(I) complexes and possibility for study of structure-activity relationships during investigations of their in vitro biological activity.

Silver(I) cyanoximates with ligands shown in Scheme 2 have 1:1 stiochiometry and are poorly soluble in aqueous/alcohol solutions and thus can be conveniently separated from the reaction mixture. These AgL complexes are also insoluble in hydrocarbons, acetone, but are sparingly soluble in CH₃CN. Dry, solid Ag(I) cyanoximates have shown significant thermal stability and do not decompose upon heating to 150° C.

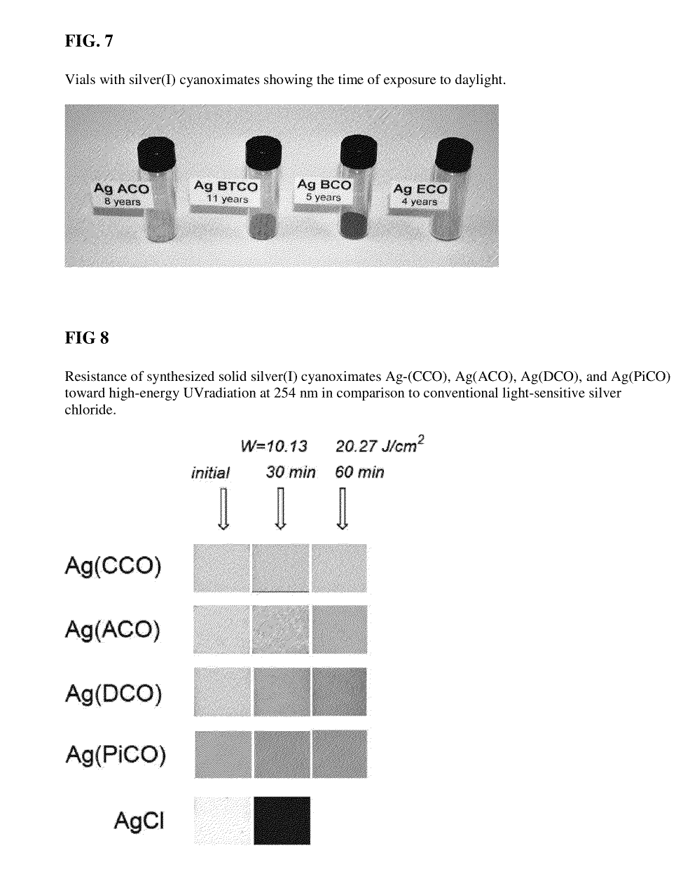

Visible spectra of fine suspensions of studied Ag(I) cyanoximates in mineral oil revealed broad ligand-based single band in the range of 400-500 nm that corresponds to π→π* transition in the nitroso chromophore. Obtained data of electron spectroscopy allowed estimation of the band gap in AgL, which turned out to be in the range of 3.00-3.55 eV. What is the most important for current studies is that all synthesized AgL are light insensitive as was shown after many years of their exposure to daylight without change (FIG. 7), and also to the short wavelength (254 nm) UV radiation (FIG. 8). At that point it was clear that the explanation for a remarkable light insensitivity of these complexes rests in their solid-state structures. Despite the poor solubility of compounds in water, alcohols, acetone, and other common organic solvents, single crystals of Ag(I) cyanoximates were grown which were suitable for the X-ray analysis. A thermostat with slow cooling of hot saturated AgL solutions within 5-6 days was used for crystal growth.

Crystal Structures. Details of determined crystal structures of Ag(ACO), Ag(DCO), Ag(PiCO), and Ag(ECO) are shown in FIGS. 4, 5, and 6 below in a way rather traditional for inorganic chemistry: the one cyanoxime ligand and closest metal centers, coordination polyhedron of silver(I) cation, and organization of the crystal lattice, respectively. All these compounds represent coordination polymers of different complexity in which the metal center is covalently bound to ligands since Ag—O and Ag—N distances are significantly shorter than the sum of van der Waals radii of involved atoms equal to 3.24 and 3.27 \acute{Å}, and even ionic radii of 2.58 and 2.97 \acute{Å}, respectively. The only basic description of crystal structures is given below, while the complete set of bond lengths and valence angles—especially around metal centers—can be found in CIF files.

Ag(ACO). This complex represents layered 2D coordination polymer in which cyanoxime anion acts as both a chelating ligand and a bridging group utilizing oxygen atoms of the amide and nitroso groups (FIG. 4A). Bond lengths in a planar five-membered chelate ring are Ag(1)-N(1)=2.352 and Ag(1)-O(2)=2.455 \acute{Å} with the “bite angle” N(1)-Ag(1)-O(1)=68.11°. The anion in the structure of Ag(ACO) is planar, in the nitroso form and adopts cis-anti configuration. This configuration of the oxime anion is contrary to the trans-anti found in organotin(IV), organotellurium(IV), and organoantimony(V) complexes, but similar to that observed in Ni(II) complexes, where the ligand is in the nitroso form as well. The peculiarity of this structure is rather short “argentophilic” interactions at 3.1934(8) \acute{Å} between Ag(I) centers in the 2D polymer propagating along the c axis (FIG. 6). For comparison, the Ag—Ag single bond is 2.889 \acute{Å}, while the Ag—Ag distance in metallic silver (Fm3m; f.c.c.) is 4.086 \acute{Å}. With consideration of argentophilic interaction the coordination number of silver(I) center in Ag(ACO) is eight (FIG. 5A). The H-bonding in the amide group is important for the stabilization of the structure since the only one hydrogen atom of the amide group in the anion is engaged in interlayer H-bonding, while the second hydrogen is involved in intralayer H-bonding with the oxygen atom of the nitroso group of neighboring anion.

Ag(DCO). This complex also represents a 2D layered coordination polymer (FIG. 6B) but differently organized than that in the structure of Ag(ACO). Thus, the anion acts as a bridge between two silver(I) centers rather than a chelator (FIG. 4B). Contrary to the structure of Ag(ACO), the CN-group of the anion in the structure of Ag(DCO) is involved in coordination to the metal center. The anion is not planar, and there are two planes in its structure in the complex: O(2)-N(1)-C(1)-C(2)-N(2) and C(5)-N(3)-C(4)-C(3) with a dihedral angle of 40.05° between them. The oxygen atom O(1) is off the latter plane by 0.245 \acute{Å}. The DCO⁻ anion forms a conditional chelate ring with Ag atom: there is no planarity in the Ag(1)-N(1)-C(1)-C(3)-O(1) ring, and the distance Ag(1)-O(1) (2.582 \acute{Å}, FIG. 4) represents a long interaction between these atoms. Moreover, the oxygen atom O(1) acts as a bridge between two silver(I) atoms, and its other contact to the metal center is in 2.697 \acute{Å} in length. Also, O(1) atom is off the plane Ag(1)-N(1)-O(2)-C(1)-C(3) by 0.596 \acute{Å}, which is another indication of its electrostatic involvement into coordination to the silver atom. Thus, the coordination number of Ag(I) in the complex is two, with two long electrostatic contacts from the oxygen atom of the amide group (FIG. 5B). The anion is in the nitroso form and adopts cis-anti configuration similar to that in its Cu(II) complex, which is opposite to the trans-anti configuration found in structures of HDCO and Ph₄Sb(DCO). The bond length Ag(1)-N(2) is a record short—2.128 \acute{Å}, and followed by bond Ag(1)-N(1)=2.217 \acute{Å} (FIG. 5B). The almost linear arrangement between them at the angle N(1)-Ag(1)-N(2)=166.11° is responsible for the formation of polymeric chains which run along the c direction and joined together by bridging O(1) atom (with long contacts Ag(1)-O(1) and the angle O(1)-Ag—O(1)′=88.48° between chains) into an elegant 2D layered structure (FIG. 6B). In the crystal, there are also van der Waals interactions between methyl groups of adjacent layers. Silver(I) atoms form linear arrays parallel to the c direction with intermetallic separation of 3.684 \acute{Å}—longer than any reasonable metallophilic interactions.

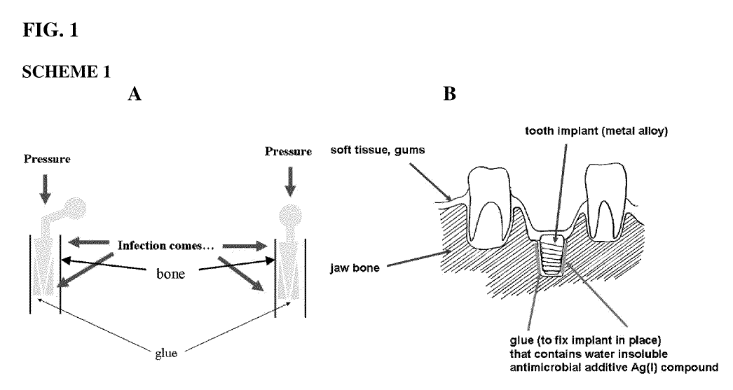

Ag(PiCO). The crystal structure of this compound is a layered 2D coordination polymer as well (FIG. 6C). The anion performs bridging function between four different silver(I) atoms (FIG. 4C). Similar to the structure of Ag(ACO), the oxygen atom of the nitroso-group acts as a bridge between two metal centers (FIG. 4C). There are three short covalent bonds in the coordination polyhedron: two bonds between Ag(I) and oxygen atoms O(1) and O(1)′ of this bridging nitroso-group and the nitrogen atom of this group (FIGS. 1C and 2C). The distance Ag(1)-O(2)=2.614 \acute{Å} is even longer than that in the structure of Ag(DCO) discussed above. Again, there is long interaction between these two atoms in Ag(1-N(1)-C(1)-C(3)-O(2) arrangement, which is no-planar with the dihedral angle between mean planes Ag(1)-O(2)-C(3) and Ag(1)-N(1)-C(1) equal to 21.25°. This situation is similar to the structure of Ag(DCO), and it should be mentioned that in chelate complexes, five-membered rings are typically planar. The anion is in the nitrosoform (bond length N(1)-O(1) is shorter than C(1)-N(1), and adopts cis-anti configuration. The cyano group is bent (angle C(1)-C(2)-N(2)=170.85°) and reflects its unusual bridging role between two metal centers: the angle Ag(1)-N(2)-Ag(1)′=84.95° (FIG. 4C). The nitrogen atom N(2) is not coordinated to these silver atoms due to geometrical restrictions imposed by its lone pair situated further along the C(2)-N(2) bond. Thus, angles Ag(1)-N(2)-C(2), Ag(1)′-N(2)-C(2), and Ag(1)-N(2)-Ag(1)′ are 90.65°, 118.38°, and 84.95 respectively, and are highly improper in value to be considered for binding of the cyano group. For comparison, the angle Ag—N(5)-C(5) in the linearly coordinated CN-group in the structure of Ag(DCO) is 164.65°, while a similar angle Ag(1)-N(2)-C(2) is 171.26° in the structure of Ag(ECO) (FIG. 5D). Therefore, coordination polyhedron of the Ag(I) center in Ag(PiCO) has a slightly distorted and practically planar trigonal geometry (FIG. 5C). 2D layers in the structure of the complex are run along the c direction. Van der Waals interactions between t-butyl groups of anions exist between layers (FIG. 6C). The shortest Ag—Ag distance in this complex is 3.591 \acute{Å}.

Ag(ECO). This is the first known structure containing this cyanoxime ligand. The crystal structure of this complex follows already described Ag(DCO) and Ag(PiCO) and also represents layered 2D coordination polymer (FIG. 6D). The ethoxy group in this complex is disordered by two positions with almost equal occupancies: 0.497 and 0.503. Ag(ECO) structures presented in FIGS. 4-6 structures contain only a major domain with its minor image along C(1)-C(3) direction omitted for clarity. The ECO⁻ anion in this complex also acts as a bridging ligand between four different silver(I) centers (FIG. 4D). All four bonds between the Ag(I) center and surrounding anions are covalent with those to nitrogen atoms N(1) and N(2) being especially short (FIG. 5D). Coordination polyhedron of the metal center in this complex is well described as a seesaw. The anion is in the nitroso-form and adopts a surprisingly planar trans-anti configuration of its cyanoxime core. The shortest Ag—Ag distance here is 3.587 \acute{Å}.

Determined single crystal structures of silver(I) cyanoximates described here silver(I) cyanoximates truly reflect structures of bulk materials since their calculated and experimental powder XRD patterns are in a good agreement.

### Example 3

### Light Stability (Insensitivity) of Silver(I) Cyanoximates

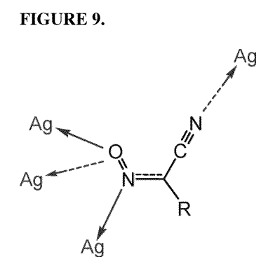

Photophysical Part: UV-Light Stability Studies. Silver(I) cyanoximates with chelating ligands shown in Scheme 2 exhibited a remarkable visible light insensitivity for years of direct exposure to daylight (FIG. 7). This convenient property coupled with antimicrobial activity makes synthesized complexes potentially valuable materials for their investigations as additives to acrylate glues during introduction of indwelling medical devices such as prosthetic joints and dental implants. These polymeric composites are cured within several minutes with UV-light that causes cross-linking and solidifying of the mass into a hard material. Therefore, studies of stability of Ag(I) cyanoximates toward short wavelength UV-radiation validated their choice for further practical considerations. Results of testing are shown in FIG. 8 and indicate great stability of examined silver(I) cyanoximates for a prolonged period of time to doses of UV-radiation that completely darken ionic AgC1 used as control photosensitive substance. That means that fine powders of AgL survive intact during UV-irradiation sufficient for polymerization of the acrylate composite material, which opens the possibility for their further development for in vivo experiments and preclinical and clinical studies. The origin for such significant resistance toward visible and UV-light is in the structures of complexes. In order to show light insensitivity a compound should: (a) form a coordination polymer organized in a manner of zigzag chains or 2D sheets; (b) contain at least two short covalent bonds between silver(I) and nitrogen atoms of the ligand; (c) contain a bridging oxime/nitroso group. Therefore, based on six established up-to-date crystal structures of light stable Ag-cyanoximates (four in this work and the other two are Ag(BCO) and Ag(CCO)), the light-insensitive motif can be deduced in oxime-based silver(I) complexes to one in FIG. 9.

After many hours of intense short-wavelength UV-radiation powdery samples of Ag-cyanoximates eventually become darkened. It should be noted that for the purpose of intended application of synthesized compounds—as antimicrobial light-insensitive additives to adhesives for indwelling medical devices—only minutes of light stability are required. The source of a dark color in final products of degradation is metallic silver that is in the colloidal state. This conclusion is based on comparative analysis of the XRD patterns of fine metallic silver powder (obtained from substitution reaction between A1 wire and AgNO₃ aqueous solution at 293 K, pH=6.0) and those for the initial Ag-cyanoximates, and same complexes darkened after UV-light exposure. Thus, no lines corresponding to metal Ag were observed in the Θ-2Θ XRD scans. This is attributed to two factors: (1) to the small size of silver particles estimated to be less than ˜100 \acute{Å}, and (2) small physical quantity of produced metallic silver. A typical sample mass of initial AgL spread over the cardboard used in the UV-irradiation studies did not exceed 40-50 mg However, characteristic peaks of “plasmon” bands of colloidal silver at 380-450 nm were detected in UV-visible spectra of exposed Ag-cyanoximates in DMSO or Py in addition to the Tyndall effect. Both these features showed colloidal state of metal present in UV-light exposed samples.

### Example 4

### Antibacterial Activity of Silver(I)-Cyanoximates

Biological Part: In Vitro Assessment of Antibacterial Activity of Silver(I)-cyanoximates. Studies in Solutions. All 10 cyanoximates exhibited antimicrobial activity against the tested infection agents. The lowest MIC value was detected for Ag(DCO) and Ag(PICO), which indicated their highest activity. These data suggested that hydrophobic methylated cyanoximes ( ) showed stronger inhibitory effect possibly due to their interactions with cell membranes which may help in complexes' intracellular uptake. However, the solubility of silver(I) cyanoximates in DMSO and DMF is limited, and, therefore, there was a need in conducting experiments with solid samples of synthesized AgL. This was achieved by using dried paper disks presoaked with AgL solution. Seven out of 10 compounds were studied in this manner. Investigated compounds soluble in DMF were remarkably more effective against clinical isolates from nosocomial infections than to strains from the Collection of Microorganisms.

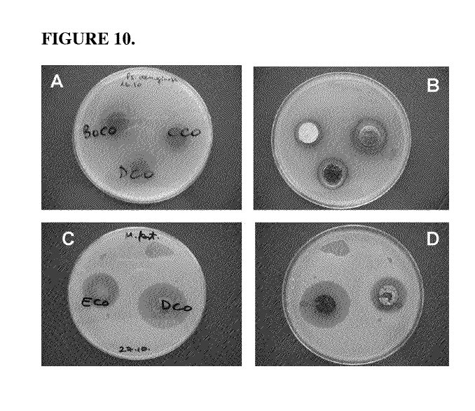

Solid State Studies. Seven cyanoximates (Ag(BCO), Ag(CCO), Ag(DCO), Ag(ECO), Ag(BIMCO), Ag(BOCO), and Ag(PiCO)) were deposited on filter papers and tested for their effect on bacterial growth on solid media. The inhibition zones of microbial growth was examined. The results demonstrated that studied Ag(I) cyanoximates exhibit antimicrobial activity in the solid state as well, but their efficiency was strain dependent. Furthermore, we tested the antimicrobial effect of the silver(I) cyanoximates deposited as pressed pellets (12 mm in diameter) against five strains of microorganisms grown on agar plates. FIG. 10 shows two examples of growth inhibition experiments and demonstrated clear inhibition zones in Pseudomonas aeruginosa growth and Mycobacterium fortuitum in the presence of Ag(BOCO), Ag(CCO), Ag(DCO), and Ag(ECO) pellets. All seven tested silver(I) cyanoximates inhibit bacterial growth and can be used as agents to prevent infections and biofilm formations.

Changes may be made in the above compositions and methods without departing from the scope hereof. It should thus be noted that the matter contained in the above description should be interpreted as illustrative and not in a limiting sense.

### REFERENCES All references cited throughout the text or listed below are hereby incorporated into this disclosure as if fully reproduced herein.

Gerasimchuk N., et al., Inorg. Chem. 49:9863-74 (2010).

What is claimed:

1. A method for treating indwelling medical devices to eliminate microbes, comprising the steps of: applying a water-insoluble silver cyanoximate to the surface of the indwelling medical device prior to or during the introduction of the indwelling medical device into a patient.

2. The method of claim 1 wherein the silver cyanoximate is selected from the group consisting of: 2-(Oximido)-2-benzoxazoleacetonitrile Silver(I), Ag(BOCO); Silver(I) Nitrosodicyanomethanide, Ag(CCO); Silver(I) α-Oximido-(acetamide)acetonitrile, Ag(ACO); Silver(I) α-Oximido-([N,N-dimethylamine]acetamide)acetonitrile, Ag(DCO); Silver(I) α-Oximido-(ethylacetoxy)acetonitrile, Ag(ECO); Silver(I) α-Oximido-(2-pivaloyl)acetonitrile, Ag(PiCO); Silver(I) α-Oximido-(2-benzoyl)acetonitrile, Ag(BCO); Silver(I) α-Oximido-(2-pyridyl)acetonitrile, Ag(2PCO); Silver(I) α-Oximido-(2-[N-methyl]benzoimidazolyl)acetonitrile, Ag(BIMCO); Silver(I) α-Oximido-(2-benzothiazolyl)acetonitrile, Ag(BTCO).

3. An antimicrobial additive to acrylate glue for securing an indwelling medical device, said additive comprising at least one silver cyanoximate.

4. The additive of claim 3 wherein the silver cyanoximate is selected from the group consisting of: 2-(Oximido)-2-benzoxazoleacetonitrile Silver(I), Ag(BOCO); Silver(I) Nitrosodicyanomethanide, Ag(CCO); Silver(I) α-Oximido-(acetamide)acetonitrile, Ag(ACO); Silver(I) α-Oximido-([N,N-dimethylamine]acetamide)acetonitrile, Ag(DCO); Silver(I) α-Oximido-(ethylacetoxy)acetonitrile, Ag(ECO); Silver(I) α-Oximido-(2-pivaloyl)acetonitrile, Ag(PiCO); Silver(I) α-Oximido-(2-benzoyl)acetonitrile, Ag(BCO); Silver(I) α-Oximido-(2-pyridyl)acetonitrile, Ag(2PCO); Silver(I) α-Oximido-(2-[N-methyl]benzoimidazolyl)acetonitrile, Ag(BIMCO); Silver(I) α-Oximido-(2-benzothiazolyl)acetonitrile, Ag(BTCO).

5. A method for prevention of biofilm formation on an indwelling medical device, said method comprising incorporating silver cyanoximate to the surface of the indwelling medical device.

6. The method of claim 5 wherein the silver cyanoximate is selected from the group consisting of: 2-(Oximido)-2-benzoxazoleacetonitrile Silver(I), Ag(BOCO); Silver(I) Nitrosodicyanomethanide, Ag(CCO); Silver(I) α-Oximido-(acetamide)acetonitrile, Ag(ACO); Silver(I) α-Oximido-([N,N-dimethylamine]acetamide)acetonitrile, Ag(DCO); Silver(I) α-Oximido-(ethylacetoxy)acetonitrile, Ag(ECO); Silver(I) α-Oximido-(2-pivaloyl)acetonitrile, Ag(PiCO); Silver(I) α-Oximido-(2-benzoyl)acetonitrile, Ag(BCO); Silver(I) α-Oximido-(2-pyridyl)acetonitrile, Ag(2PCO); Silver(I) α-Oximido-(2-[N-methyl]benzoimidazolyl)acetonitrile, Ag(BIMCO); Silver(I) α-Oximido-(2-benzothiazolyl)acetonitrile, Ag(BTCO).
